(19) United States
(12) Patent Application Publication
(10) Pub. No.: US 2005/0158535 A1
(43) Pub. Date: Jul. 21, 2005

(54) Methods for making porous ceramic structures

(76) Inventors: Miqin Zhang, Bothell, WA (US); Hassna Ramay, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/846,356

(22) Filed: May 14, 2004

Related U.S. Application Data
(60) Provisional application No. 60/471,054, filed on May 15, 2003.

(51) Int. Cl. B32B 3/26

(52) U.S. Cl. 428/304.4

(57) ABSTRACT

In one aspect, the present invention provides methods for making porous ceramic structures. In another aspect, the present invention provides porous ceramic structures that have a compressive strength of greater than about 5 MPa. In another aspect, the present invention provides methods for growing bone.

### CROSS-REFERENCE TO RELATED APPLICATION

This application claims the benefit of U.S. Provisional Application 60/471,054, filed May 15, 2003.

### GOVERNMENT RIGHTS

This invention was made with government support awarded by the National Science Foundation, Contract No. EEC-9529161. The government has certain rights in the invention.

### FIELD OF THE INVENTION

The present patent application relates to porous ceramic structures that are useful, for example, as scaffolds that support the growth of bone tissue in vivo or in vitro, and to methods for making porous ceramic structures.

### BACKGROUND OF THE INVENTION

New bone tissue can be grown in vivo or in vitro using a biocompatible structure (usually referred to as a scaffold) that physically supports growth of bone cells and blood vessels. A scaffold should preferably provide mechanical support for the growing bone, and, when implanted into a living body, should gradually degrade over time into non-toxic molecules that a living body can metabolize and/or excrete.

Calcium phosphate, a major component of natural bone, has been used in medicine and dentistry to make scaffolds for supporting the growth of bone. Hydroxyapatite is a form of calcium phosphate that is biocompatible, and that interacts favorably with soft tissue and bone, and has been used as a bone scaffold (see, e.g., Bucholz, R. W., et al., Orthop. Clin. North Am. 18: 323-334 (1987); Klawitter, J. J., and Hulbert, S. F., J. Biomed. Mater. Res. 2: 161-229 (1971); Hench, L. L., J. Am. Ceram. Soc. 74: 1437-1451 (1991)).

A number of techniques have been developed to fabricate porous hydroxyapatite scaffolds. In one technique, volatile organic particles are included in hydroxyapatite powder. This technique produces a porous structure of closed, poorly interconnected, non-uniform pores (see, e.g., Lyckfeldt, O., and J. M. F. Ferreira, J. Eur. Ceram. Soc. 18: 131-140 (1998); Engin, N. O., and A. C. Tas, J. Eur. Ceram. Soc. 19: 2569-2572 (1999); Engin, N. O., and A. C. Tas, J. Am. Ceram. Soc. 83: 1581-1584 (2000)).

Gel casting of foams is a method for rapidly forming porous ceramic structures by in situ polymerization. Foams created in a ceramic slurry by agitation, resulting in a porous structure after polymerization and sintering. The chemical reagents used in this process are eliminated by heating, and the sintered material is non-toxic to living tissues, allowing this material to be used for biomedical applications. This technique produces scaffolds with considerable mechanical strength, but a poorly interconnected and non homogeneous porous structure (see, e.g., Sepulveda, P., et al., J. Biomed. Mater. Res. 50: 27-34 (2000); Chu, T. M. G., et al., J. Mater. Sc. 12: 471-478 (2001)).

In the polymer sponge method for making porous ceramic structures, a thin layer of ceramic slurry is coated on the surface of a porous polymer sponge. After incinerating the polymer skeleton, a positive replica of the sponge is obtained, but the layer of ceramic slurry coating on the polymer sponge forms very thin walls between pores, which provides low mechanical strength. Consequently, hydroxyapatite scaffolds prepared using the polymer sponge method have a controllable pore size, interconnected pores, and desired geometry, but have poor mechanical strength for load-bearing applications (see, e.g., Tian, J., and J. Tian, J. Mater. Sc. 36: 3061-3066 (2001); Zhang, Y., and M. Zhang, J. Biomed. Mat. Res. 61: 1-8 (2002); Luyten, J., et al., Key Eng. Mater. 206-213: 1937-1940 (2002); Lange, F. F., and K. T. Miller, Advan. Ceram. Mater. 2: 827-831 (1987); Powell, S. J., and J. R. G. Evans, Mater. Manuf Proc. 4: 757-771 (1995).

A porous scaffold promotes cell attachment, proliferation, and differentiation, and provides pathways for biofluids within the scaffold. Consequently, a highly porous structure, having interconnected pores, generally favors the growth of cells and blood vessels within a scaffold. A material generally weakens, however, as its porosity increases, which poses a major challenge in developing load-bearing scaffolds. Because of their natural brittleness, ceramics such as hydroxyapatite, in a porous form, have very low strength and toughness. Thus, despite their favorable biological properties, the poor mechanical properties of these ceramic materials have limited their clinical applications.

The present invention provides methods for making porous ceramic structures that have a controllable, interconnected, pore structure and a high compressive strength.

### SUMMARY OF THE INVENTION

In one aspect, the present invention provides methods for making porous ceramic structures. The methods of this aspect of the invention include the steps of (a) contacting a porous body, defining a multiplicity of pores, with a liquid ceramic composition for a period of time sufficient for the liquid ceramic composition to penetrate the pores; (b) polymerizing the liquid ceramic composition that has penetrated the pores; and (c) destroying the porous body to produce a porous ceramic structure. The porous ceramic structure is sintered to harden the structure.

The present invention also provides porous ceramic structures that each have a compressive strength of greater than about 5 MPa, and a porosity of between about 40% and about 78%. The porous ceramic structures of the present invention are useful for any purpose that requires a porous ceramic structure. For example, the porous ceramic structures of the present invention are useful as scaffolds to support the growth of bone cells and blood vessels in vivo or in vitro, as described more fully herein. Porous ceramic structures of the invention that are to be implanted into a living body (e.g., a human body) are typically completely, or substantially, resorbable by the body. Porous ceramic structures of the invention can be used as filters.

In another aspect the present invention provides methods for growing bone (e.g., mammalian bone). The methods of this aspect of the invention include the step of culturing bone cells in a porous ceramic scaffold, that has a compressive strength of at least about 5 MPa, and a porosity of between about 40% and about 78%, for a period of time, and under conditions, sufficient for bone to form within the scaffold.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a drawing of a spherical, porous, ceramic structure of the present invention.

FIG. 2 is a drawing of a magnified portion of the spherical, porous, ceramic structure of FIG. 1.

FIG. 3 is an electron micrograph of a portion of a porous hydroxyapatite structure prepared as described in Example 1.

FIG. 4 shows the elastic modulus of porous hydroxyapatite structures prepared from slurries having different hydroxyapatite concentrations as described in Example 1.

FIG. 5 shows the compressive yield strength of porous hydroxyapatite structures prepared from slurries having different hydroxyapatite concentrations as described in Example 1.

### DETAILED DESCRIPTION OF THE PREFERRED EMBODIMENT

In one aspect, the present invention provides methods for making porous ceramic structures. The methods of this aspect of the invention include the steps of (a) contacting a porous body, defining a multiplicity of pores, with a liquid ceramic composition for a period of time sufficient for the liquid ceramic composition to penetrate the pores; (b) polymerizing the liquid ceramic composition that has penetrated the pores; and (c) destroying the porous body to produce a porous ceramic structure. The porous ceramic structure is sintered to harden the structure.

Useful liquid ceramic compositions are typically aqueous compositions. Useful liquid ceramic compositions include at least one ceramic powder that forms a solid ceramic composition when the liquid ceramic composition is sufficiently heated. The term “liquid” in this context encompasses slurries and other viscous, liquid, compositions, that include ceramic powder that may be dissolved in the liquid ceramic composition, or may be dispersed (although not substantially dissolved) therein.

Representative examples of ceramic powders that can be included in the liquid ceramic compositions are hydroxyapatite (abbreviated as HA), β-tricalcium phosphate (β-Ca₃(PO₄)₂, abbreviated as β-TCP) and any form of bioglass. In the context of the present invention, a bioglass is considered to be a form of ceramic. Bioglasses are described, for example, by Larry L. Hench, Bioceramics, Journal of the American Ceramic Society, 81: 1705-1728 (1998). The concentration of the ceramic powder is sufficient to produce a porous ceramic structure that has desired mechanical properties, such as a desired compressive strength. An exemplary concentration range for the amount of ceramic powder in the liquid ceramic composition is from about 10% (w/w) to about 60% (w/w). More specifically, exemplary concentration ranges for the amount of ceramic powder in the liquid ceramic composition is from about 30% to about 40%, or from about 40% to about 50%, or from about 50% to about 60%. Throughout the present patent application, all concentrations of chemical substances that are expressed as percentages are percentages by weight, unless otherwise indicated. Throughout the present patent application, when the term “about” is used to qualify a percentage (e.g., about 40%), the exact numerical value of the percentage is included in the term “about” (e.g., the term “about 40%” encompasses exactly 40%).

The liquid ceramic compositions may include a dispersant that promotes dispersion of the ceramic powder throughout the liquid ceramic composition. Representative examples of useful dispersants include methacrylates, such as the polymethacrylate sold under the tradename Darvan C by Vanderbilt Company Inc., Norwalk, Conn. Representative examples of other useful dispersants include sodium silicate, sodium carbonate, sodium borate, sodium polyacrylate, ammonium polyacrylate, sodium succinate, and sodium polysulfonate. The concentration of dispersant that is included in the liquid ceramic composition mainly depends on the concentration of the ceramic powder in the liquid ceramic composition, and can be established by routine experimentation. Typically, the concentration of dispersant in the liquid ceramic composition is about 1% of the weight of ceramic powder in the liquid ceramic composition.

The liquid ceramic compositions may include a surfactant, such as Surfonal® (available from Air Products and Chemicals, Inc., Performance Chemicals Division, 7201 Hamilton Boulevard, Allentown, Pa. 18195-1501). Other representative examples of useful surfactants include sodium dodecyl sulfate, sodium lauryl sulfate and octylphenoxypolyethoxyethanol. The concentration of surfactant in the liquid ceramic composition is typically in the range of from 0.1% to 0.2% of the volume of the liquid ceramic composition.

Porous bodies useful in the practice of the methods of this aspect of the invention have a porous structure wherein all, or substantially all (e.g., greater than 90%, or greater than 95%, or greater than 99%), of the pores are connected to at least one other pore within the porous body. Examples of useful porous bodies include solid foams, such as sponges, including elastically deformable sponges. When a porous body is contacted with the liquid ceramic composition (e.g., immersed in the liquid ceramic composition), the liquid ceramic composition penetrates the pores throughout most or all of the porous body. Consequently, the architecture of the pores substantially determines the internal architecture of the ceramic structure produced by the methods of the invention. Exemplary foams useful in the practice of the invention include polyurethanes, and polyesters.

A porous body is contacted with a liquid ceramic composition for a period of time, and under suitable conditions, sufficient for the liquid ceramic composition to penetrate all, or substantially all (e.g., greater than 90%, or greater than 95%, or greater than 99%), of the pores within the porous body. By way of example, the porous body can be immersed in the liquid ceramic composition. Penetration of the liquid ceramic composition into the pores of a porous body can be facilitated by subjecting the porous body (immersed in the liquid ceramic composition) to a vacuum, which also helps to remove air bubbles trapped in the porous body and liquid ceramic composition. Again, by way of example, penetration of the liquid ceramic composition into the pores of a porous body can be facilitated by spraying the porous body with liquid ceramic composition at high pressure.

The period of time during which the porous body is contacted with a liquid ceramic composition depends on such factors as the size and density of the pores in the porous body, and the viscosity of the liquid ceramic composition. For example, a more viscous liquid ceramic composition typically takes longer to penetrate the pores of a porous body than a less viscous liquid ceramic composition. Again by way of example, a liquid ceramic composition typically takes longer to penetrate smaller pores than larger pores. One of ordinary skill in the art can readily determine a suitable time period to permit a liquid ceramic composition to penetrate a porous body. The porous body can be contacted with the liquid ceramic composition under a vacuum in order to reduce the time required for the liquid ceramic composition to penetrate the pores within the porous body. For example, the porous body can be contacted with the liquid ceramic composition under a vacuum for a period of less than half an hour, such as from five minutes to ten minutes.

Any useful polymerizing agent (or combination of polymerizing agents) can be used to polymerize the liquid ceramic composition that has penetrated the porous body. A representative example of a combination of polymerizing agents is acrylamide and methylenebisacrylamide. Polymerization of these agents can be initiated by adding ammonium persulphate and N,N,N,N′tetramethylethylenediamine. Other representative examples of useful polymerizing agents (or combinations thereof) include the combination of 2-hydroxyethyl methacrylate and ethylene dimethacrylate as polymerizing agents, n-methyl-2-pyrrolidone as cosolvent, and dibenzoyl peroxide as initiator.

The polymerizing agent (and/or any necessary polymerization initiating agent) can be added to the liquid ceramic composition before or during the time period that the porous body is contacted with the liquid ceramic composition. In embodiments of the invention in which a combination of polymerizing agents is used, one or all of the polymerizing agents (and/or any necessary polymerization initiating agent) can be added to the liquid ceramic composition before or during the time period that the porous body is contacted with the liquid ceramic composition. For example, if the combination of acrylamide and methylenebisacrylamide is used, one or both of these agents can be added to the liquid ceramic composition before or during the time period that the porous body is contacted with the liquid ceramic composition, provided that these agents are able to thoroughly mix within the liquid ceramic composition. Typically, though, the polymerizing agent (or combination thereof) is/are added to the liquid ceramic composition before the porous body is contacted with the liquid ceramic composition.

If a porous body is immersed in liquid ceramic composition until the liquid ceramic composition penetrates the porous body, the porous body may be removed from the liquid ceramic composition before the liquid ceramic composition is polymerized, or the liquid ceramic composition can be polymerized while the porous body is still immersed therein. Thus, for example, a porous body may be immersed in a liquid ceramic composition, for a period of time sufficient to permit the liquid ceramic composition to penetrate substantially all of the pores defined by the porous body, then the liquid ceramic composition is polymerized while the porous body is immersed therein, and the porous body is then removed (e.g., by cutting) from the mass of polymerized ceramic composition that surrounds the porous body.

After polymerization of the liquid ceramic composition the porous body is then destroyed. For example, the porous body can be destroyed by incineration, or, for example, by dissolution in a solvent, or, for example, by degradation in a substance that chemically degrades the porous body. Typically, the porous body is destroyed by incineration at a temperature that both incinerates the porous body and sinters the porous ceramic structure. For example, the sintering temperature of calcium phosphate is 1300° C. for Ca/P ratio between 1.5 and 1.7. The Ca/P ratio of hydroxyapatite is 1.67 and that of tricalcium phosphate is 1.5. The sintering rate is typically in the range of from 1° C./min to 3° C./min, with a dwell time (at the sintering temperature) typically of from 1 hour to 2 hours.

Optionally, the porous body may be first incinerated, then the temperature is raised to sinter the porous ceramic structure. For example, the temperature ramp rate for incinerating polyurethane foam can be between 0.5° C./min to 1° C./min. A slow ramp rate is preferred so that there is ample time for the porous ceramic structure to stabilize. The temperature for incinerating the polyurethane foam may be between 500° C. to 650° C. This temperature may be maintained, for example, from 1 hour to 3 hours to completely incinerate the foam. Thereafter the porous ceramic structure can be sintered.

Sintering typically incinerates all of the porous body and the polymer, and other organic components, to produce a porous ceramic structure that consists essentially of ceramic material (although traces of non-ceramic material may remain).

In a specific embodiment, the present invention provides a method for making porous ceramic structures, wherein the method includes the steps of (a) preparing a liquid ceramic composition comprising acrylamide, methylenebisacrylamide, hydroxyapatite, Surfonal®, and Darvan C; (b) mixing the liquid ceramic composition (e.g., by ball milling); (c) subjecting the liquid ceramic composition to a vacuum to remove a portion (preferably substantially all) of the oxygen dissolved within the liquid ceramic composition; (d) adding ammonium persulphate and N,N,N,N′tetramethylethylenediamine to the liquid ceramic composition; (e) immersing a solid foam in the liquid ceramic composition for a period of time sufficient for the liquid ceramic composition to penetrate all, or substantially all, of the pores defined by the porous body; (f) removing the foam from the liquid ceramic composition before polymerization of the liquid ceramic composition; (g) drying the foam, that is impregnated with the liquid ceramic composition, after the liquid ceramic composition is polymerized; and (h) heating the foam that is impregnated with the liquid ceramic composition so that the foam is incinerated, and a hard, porous, ceramic structure is produced.

The liquid ceramic composition may include nanoparticles that increase the strength of the porous ceramic structures. A nanoparticle is a particle having a longest dimension that is less than one micrometer (1 μm). For example, the length of a cylindrical nanoparticle is less than 1 μm, and the diameter of a spherical nanoparticle is less than 1 μm. Representative ranges for the length of the longest dimension of nanoparticles useful in the practice of the present invention is from 1 nm to 500 nm, such as less than 100 nm. Nanoparticles may have any shape, such as cylindrical, spherical or cubic. The concentration (expressed as percentage by weight) of nanoparticles in the liquid ceramic composition is typically no more than 10%, more typically no more than 5%. Nanoparticles can be made from any biologically compatible ceramic, such as hydroxyapatite, β-TCP, or any form of bioglass. Typically, nanoparticles included in a liquid ceramic composition have a different chemical composition than the ceramic powder present in the liquid ceramic composition (e.g., the liquid ceramic composition could contain hydroxyapatite powder and nanoparticles made from β-TCP).

The present invention also provides porous ceramic structures having both high compressive strength and high porosity. The porous ceramic structures of the present invention each have a compressive strength of greater than about 5 MPa (megaPascals), and a porosity of between about 40% and about 78%. Thus, the porous ceramic structures of the invention can have any combination of compressive strength values and porosity values provided that the compressive strength value is greater than about 5 MPa, and the porosity value is between about 40% and about 78%.

For example, some porous ceramic structures of the present invention have a compressive strength in the range of from about 5 MPa to about 10 MPa, and a porosity of between about 40% and about 78%. Some porous ceramic structures of the present invention have a compressive strength in the range of from about 5 MPa to about 10 MPa, and a porosity in the range of from about 50% to about 78%. Some porous ceramic structures of the present invention have a compressive strength in the range of from about 5 MPa to about 10 MPa, and a porosity in the range of from about 60% to about 78%. Some porous ceramic structures of the present invention have a compressive strength in the range of from about 5 MPa to about 10 MPa, and a porosity in the range of from about 65% to about 78%. Some porous ceramic structures of the present invention have a compressive strength in the range of from about 5 MPa to about 10 MPa, and a porosity in the range of from about 70% to about 78%. A method for measuring the compressive strength of porous ceramic structures is set forth in Example 2. A method for measuring the porosity of porous ceramic structures is set forth in Example 1.

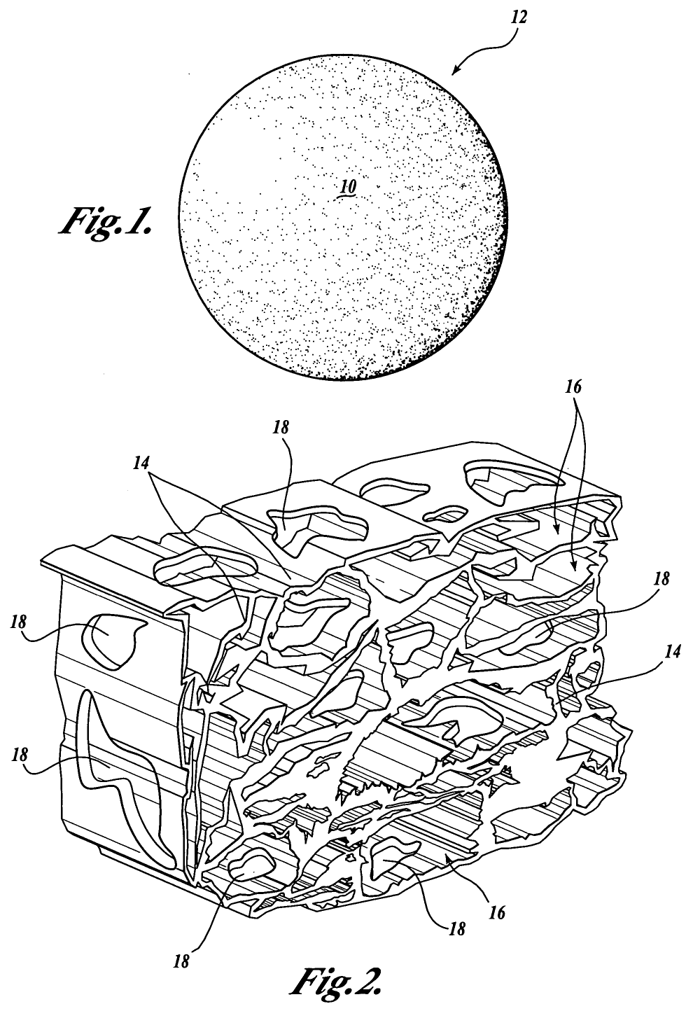

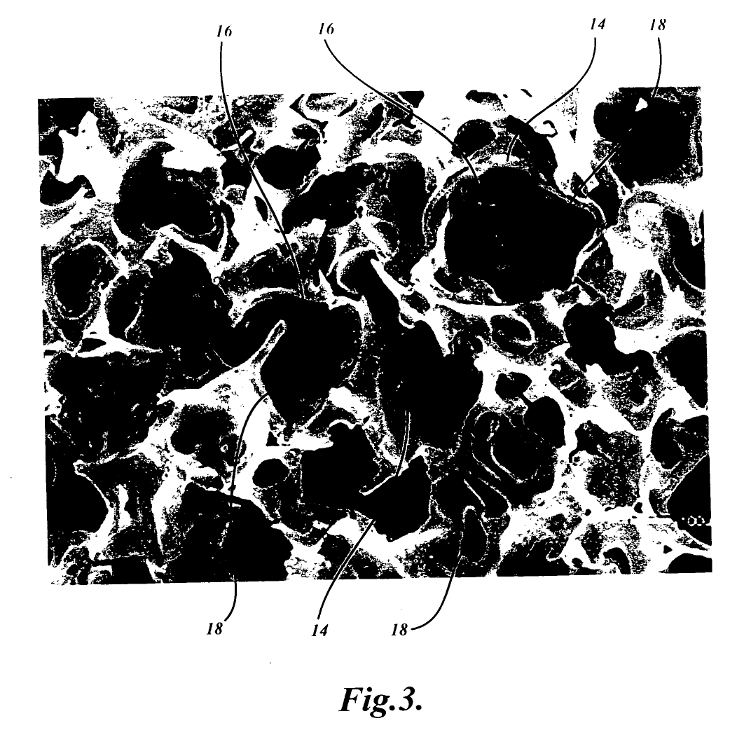

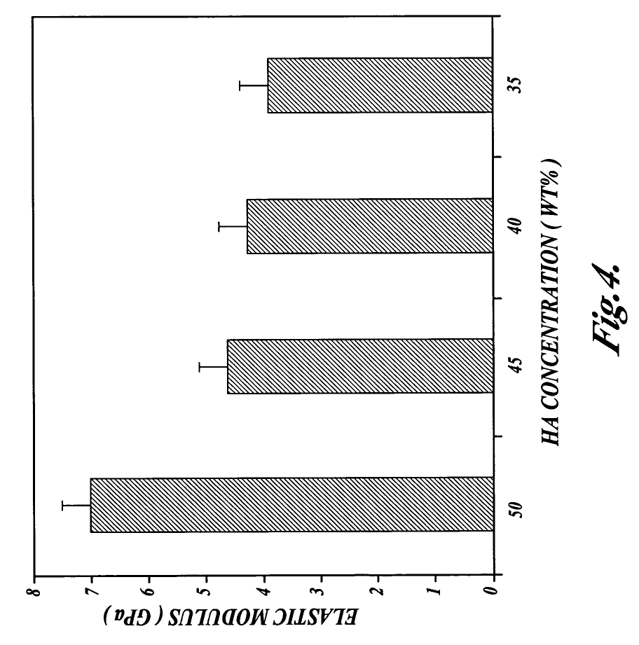

FIG. 1 shows a representative porous ceramic structure 10 of the present invention. Porous ceramic structure 10 is spherical and includes a body 12. As shown more clearly in FIG. 2, body 12 is composed of numerous pore walls 14 that define numerous pores 16. All, or substantially all, of pores 16 are connected to at least one other pore 16. For example, holes 18 in pore walls 14 connect at least some pores 16. Thus, pores 16 form an interconnected network of pores 16 within structure body 12. Pore walls 14 can optionally include nanoparticles as described herein. It will be understood that when ceramic structure 10 is made using a method of the present invention, then the architecture of pore walls 14 is primarily determined by the architecture of the interconnected spaces within the porous body that is impregnated with the liquid ceramic composition, as described supra.

Although the specific embodiment of porous ceramic structure 10 shown in FIG. 1 is spherical, porous ceramic structure 10 can be made in any shape. Thus, for example, porous ceramic structure 10 can be cylindrical, cubic or pyramidal. Porous ceramic structures 10 can be any desired size. For example, porous ceramic structures 10 are useful for repairing damaged bone in a mammalian subject, or for reconstructing portions of bone removed during surgery. Spherical and cylindrical porous ceramic structures 10 are preferred for repairing or reconstructing bone in a mammalian subject (e.g., a human subject). Thus, for example, a surgeon can pack spherical and/or cylindrical porous ceramic structures 10 into a space within a damaged bone, or into the space remaining after a portion of bone has been surgically removed, and the porous ceramic structures 10 provide a physical support within which new bone cells and blood vessels grow. An exemplary range of diameters for spherical porous ceramic structures 10 useful for this purpose is from 3 mm to 10 mm, or from 5 mm to 10 mm, such as about 8 mm. An exemplary range of lengths for cylindrical porous ceramic structures 10 useful for this purpose is from 3 mm to 10 mm, or from 5 mm to 10 mm, such as about 8 mm.

Pores 16 can have any desired diameter. The diameter of pores 16 is typically expressed as an average diameter value. A method for measuring average diameter of pores 16 is set forth in Example 3. Representative values for the average diameter of pores 16, in porous structures 10 useful as supports for growing bone cells, are from about 100 μm to about 600 μm, such as from about 100 μm to about 300 μm, wherein μm is the abbreviation for micrometer.

Porous ceramic structures 10 can be made using any embodiment of the methods of the present invention for making porous ceramic structures. Thus, in another aspect, the present invention provides porous ceramic structures made by a method that includes the following steps: (a) contacting a porous body, defining a multiplicity of pores, with a liquid ceramic composition for a period of time sufficient for the liquid ceramic composition to penetrate the pores; (b) polymerizing the liquid ceramic composition that has penetrated the pores; and (c) destroying the porous body to produce a porous ceramic structure.

In another aspect the present invention provides methods for growing bone. The methods of this aspect of the invention include the steps of culturing bone cells (typically osteoblasts) in a porous ceramic scaffold that has a compressive strength of at least about 5 MPa, and a porosity of between about 40% and about 78%. The bone cells are cultured in the presence of the porous ceramic scaffold for a period of time sufficient for the cells to multiply and form bone. The bone cells can be cultured in the presence of the porous ceramic scaffold in vivo or in vitro. For example, a porous ceramic scaffold of the present invention can be infused with bone cells and the scaffold can then be implanted into the body (e.g., into a space within a bone) of a living subject (e.g., a mammal, such as a human being). New bone forms in and/or around the implanted scaffold, and, typically, the scaffold is gradually degraded over time to leave new bone tissue. Techniques for culturing bone cells in scaffolds are known to those of skill in the art. Representative techniques for culturing bone cells in scaffolds are disclosed in J. Dong et al., Biomaterials 23: 4493-4502 (2002), and in I. D. Xynos et al., Calcif Tissue Int. 67: 321-329 (2000), which publications are both incorporated herein by reference.

The following examples merely illustrate the best mode now contemplated for practicing the invention, but should not be construed to limit the invention.

### EXAMPLE 1

This Example describes the preparation, and some physical properties, of porous hydroxyapatite scaffolds prepared using the methods of the present invention.

Materials: HA (Ca₁₀(OH)₂(PO₄)₆) powder was used as received from the vendor (Sigma-Aldrich Corporation, 3050 Spruce St, St. Louis, Mo. 63103). The powder was composed of clusters of submicron crystallites and their particle size was in the range of 0.5 to 1.0 μm. It will be understood that, in the context of the present invention, the submicron crystallites are not considered to be nanoparticles, but aggregations of ceramic powder particles. Darvan C (Vanderbilt Company Inc., Norwalk, Conn.), a 25% aqueous solution of ammonium polymethacrylate, was used as the dispersant. The polymeric agents were monofunctional acrylamide, C₂H₃CONH₂ and difunctional methylenebisacrylamide (C₂H₃CONH)₂CH₂. Ammonium persulphate, (NH₄)₂S₂O₈ and N,N,N,N′ tetramethylethylenediamine were used as the initiator and catalyst, respectively. All these chemicals were purchased from Sigma-Aldrich Corporation. A silicone based defoamer, Surfonal® DF 58 (Air Products and Chemicals, Inc., Performance Chemicals Division, 7201 Hamilton Boulevard, Allentown, Pa. 18195-1501), was used as a surfactant, all the slurries were aqueous, and de-ionized (DI) water was used in all the experiments.

Preparation of Scaffolds: Hydroxyapatite along with polymeric monomers (acrylamide, methylenebisacrylamide), dispersant (Darvan C) and surfactant (Surfonal®) were mixed with distilled water to form a ceramic slurry. Table 1 shows the amount of chemicals added to distilled (DI) water to make the ceramic slurry.

TABLE 1

| Component | Amount added to 100 gm of DI water | |
|---|---|---|
| Hydroxyapatite | x¹ | gm |
| Dispersant | 1.0 | wt % of x |
| Acrylamide | 4 | gm |
| Surfactant | 0.1 | gm |
| Methylenebisacrylamide | 0.5 | gm |
| Ammonium persulphate | 0.1 | gm |
| N,N,N N′ | 0.1 | gm |
| tetramethylethylenediamine | | |

¹x = 35, 40, 45 or 50.

The slurry was deagglomerated by ball-milling for 24 hours, and subsequently de-aired under vacuum until no further release of air bubbles occurred from the slurry. Catalyst (ammonium persulphate) and initiator (N,N,N,N′ tetramethylethylenediamine) were added to the slurry to polymerize the monomers. Pieces of polyurethane foam, cut into a desired shape and size, were completely immersed in the slurry under vacuum to allow the hydroxyapatite powder particles to migrate into the pores of the foam. The amount of the catalyst and initiator were controlled to allow a sufficient time for the slurry to impregnate the polyurethane foam before gelation.

The pieces of foam were taken out of the slurry and placed in a nitrogen chamber to avoid oxygen contamination which may inhibit the polymerization process. The polymerized samples were dried in air for 24 hours, then the samples were heated at a rate of 1° C./min to 600° C. The samples were heated at this temperature for 1 hour to burn out the polyurethane foam, and then sintered at a rate of 3° C./min to 1350° C. for a dwell time of 2 hours. The process of polymer burn out was incorporated with sintering to avoid handling the ceramic structure.

Thermogravimetric Analysis: Thermogravimetric analysis (TGA) is used to measure thermal stability and composition of a material. TGA measures weight changes in a material as a function of temperature (or time) under a controlled atmosphere. TGA was used to study the pyrolysis process of the polyurethane foam, and was used to determine the temperature for incinerating the polyurethane foam. TGA was performed in a vertical tube furnace, using Netzsch STA 409C, with a heating rate of 1° C./min up to 600° C. under nitrogen flow.

Porosity and Density Measurements: A liquid displacement method was used to measure the porosity and density of the hydroxyapatite scaffolds. Density measurements provided information about pore size and distribution, permeability, and presence of structural faults in the sintered ceramic structures (see, e.g., Sepulveda, P., Am. Ceram. Soc. Bull. 76: 61-65 (1997)). A scaffold of weight W was immersed in a graduated cylinder containing a known volume (V₁) of water. The cylinder was placed in vacuum to force the water into the pores of the scaffold until no air bubbles emerged from the scaffold. The total volume of the water and scaffold was then recorded as V₂. The volume difference (V₂-V₁) was the volume of the skeleton of the scaffold. The scaffold was removed from the water and the residual water volume was measured as V₃. The total volume of the scaffold, V, was then
V=(V₂−V₁)+(V₁−V₃)=V₂−V₃ (1)

The density of the scaffold, ρ, was evaluated as,

$$ρ = \frac{W}{( {V}_{1} - {V}_{3} )} \qquad ( 2 )$$

The porosity of the open pores in the scaffold, ε, was evaluated as,

$$ɛ = \frac{( {V}_{1} - {V}_{3} )}{( {V}_{2} - {V}_{3} )} \qquad ( 3 )$$

X-Ray Diffraction Analysis: X-ray diffraction (XRD) was used to characterize the crystallinity, chemical composition, and structure of materials. XRD experiments were performed on both hydroxyapatite powder and the sintered scaffolds after being crushed to powder with a Phillips X'Pert, using CuK_{α} radiation at 20 mA, 40 kV. Scans were performed between 20 values of 10° and 70° at a rate of 0.4°/min.

Infrared Spectroscopy: Infrared Spectroscopy was used to characterize hydroxyapatite powder before and after sintering. A dried sample of 2 mg was carefully mixed with 300 mg dry KBr and pressed into a pellet using a macro KBr die kit. The solid pellet was placed in a magnetic holder. The system was purged with dry air for 1 hour to remove water vapor from the sample compartment. Polarized Fourier Transformed Infrared (FTIR) spectra of 2000 scans at 8 cm⁻¹ were obtained using a Nicolet 5DX spectrometer with a DTGS detector and a solid transmission sample compartment. Spectrum analyses were performed using standard Nicolet and Microcal Origin software. FTIR spectra were taken on both hydroxyapatite powder (used to make the sintered scaffolds) and sintered hydroxyapatite powders prepared from the sintered scaffolds.

Mechanical Testing: One of the major problems for mechanical characterization of porous ceramic scaffolds is the difficulty in machining and gripping the specimen; hence the conventional methods of mechanical characterization such as tensile, biaxial and impact testing are usually inapplicable to porous materials (see, Currey, J. D., Clin. Orthop. Rel. Res. 73: 210-231 (1970)). Instead, the compression test has been widely accepted and used successfully for characterization of cance/lous bone and porous hydroxyapatite (Hodgskinson, R., and J. D. Currey, Proceedings of the Institute of Mechanical Engineers, Part H: J. Eng. Med. 204: 115-121 (1986); Hing, K. A., et al., J. Mater. Sci. 10: 135-145 (1999)).

An Instron 4505 mechanical tester with a 10 KN load cell was used for the compression mechanical test using the guidelines set in ASTM D5024-95a. The cross head speed was set at 0.4 mm/min, and the load was applied until the scaffold was cracked. The elastic modulus was calculated as the slope of the initial linear portion of the stress-strain curve. The yield strength was determined from the cross point of the two tangents on the stress-strain curve around the yield point.

Scanning Electron Microscopy (SEM): A JEOL 5200 scanning electron microscope was used for morphological characterization of scaffolds. The samples were coated with gold/palladium under an argon atmosphere. Energy dispersive spectroscopy (EDS) (Tracor Nothem 5200) was used to provide qualitative information on the elemental composition of scaffolds.

Results: The hydroxyapatite scaffolds produced by the methods described in this Example had a three-dimensional polymeric network of pore walls composed of a substantially homogeneous polymer matrix (that did not exhibit significant hydroxyapatite particle sedimentation). Scaffolds with different geometries were formed by cutting the polyurethane foam into the required shape. Different pore sizes and geometries were achieved by using polyurethane foams having different, desired, porous structures.

Four different concentrations of hydroxyapatite slurries, 35%, 40%, 45% and 50%, were selected to evaluate the effect of hydroxyapatite concentration on the physical and mechanical properties of scaffolds. In general, increasing the concentration of hydroxyapatite increases the density, and improves the mechanical properties, of the sintered product, and reduces excessive sample shrinkage (Lange, F. F., and M. Metcalf, J. Amer. Ceram. Soc. 68: 225-231 (1985); Omatete, O. O., et al., Am. Ceram. Soc. Bull. 70: 1641-1649 (1991). High concentrations of hydroxyapatite produce a high viscosity slurry, causing difficulty in proper mixing and slurry impregnation in a polymer sponge. Therefore, 50% concentration of hydroxyapatite was selected as the highest concentration used in this experiment. The amounts of polymerizable monomers and hydroxyapatite (Table 1) were selected to obtain a uniform and workable slurry (Young, A. C., et al., J. Am. Ceram. Soc. 74: 612-618 (1991); Omatete, O. O., et al., Am. Ceram. Soc. Bull. 70: 1641-1649 (1991).

Colloidal studies on hydroxyapatite powders have shown that polyacrylate is a suitable dispersant for aqueous hydroxyapatite slurries (see, e.g., Rodriquez-Lorenzo, L. M., et al., Biomaterials 22: 1847-1852 (2001)). Darvan C, a polymethacrylate, was chosen as the dispersing agent in this study. The amount of the dispersant added affects the sintering behavior and hence mechanical properties of the scaffolds. All the slurries prepared in this study contained 1 wt % of Darvan C. Surfonal® in the slurry acts as an antifoaming agent that reduced the tendency of the formation of bridging between cell walls (see, U.S. Pat. No. 3,907,579, 1975.). Air bubbles entrapped in the slurry can lead to closed pores in the ceramic structure after drying, which decreases the density and thus mechanical strength of the ceramics (Omatete, O. O., et al., Am. Ceram. Soc. Bull. 70: 1641-1649 (1991), therefore the slurry was deaired after ball milling.

The initiator and catalyst were added to the slurry to polymerize the monomers. The polyurethane foam of desired shape was immersed in the slurry under vacuum to allow complete impregnation of the slurry into the foam. The polyurethane foam impregnated with hydroxyapatite slurry was then taken out of the slurry and placed in a nitrogen atmosphere to promote polymerization of the acrylamide monomers.

In the polymer sponge method the slurry can settle down at the bottom of the polyurethane foam during the drying process which results in a non-homogeneous porous structure after sintering. One of the advantages of the method described in this Example is rapid polymerization of slurry within the polyurethane foam resulting in a homogeneous, thick walled microstructure. Rapid drying of gelled materials formed after polymerization can cause non-uniform shrinkage leading to material cracking or warpage. Consequently, in the experiments reported in this Example the polymer foam, impregnated with hydroxyapatite slurry, was dried slowly in air for 24 hours.

The polyurethane foam should be incinerated before sintering the ceramic structure to avoid cracks in the microstructure of the ceramic structure. Thermogravimetric analysis (TGA) is one method to determine the temperature at which the complete burnout of the polyurethane foam occurred. TGA analysis showed that the polyurethane foam was completely burned out at 550° C. Thus, to allow ample time for the complete incineration of the polyurethane foam within the hydroxyapatite scaffolds before the sintering started, the heating rate was set to 1° C./min up to 600° C. with a dwell time of 1 hour.

At temperature above 1200° C., hydroxyapatite can become unstable and may lose OH groups to form decomposed products such as tetracalcium phosphate, and calcium oxide (Tampieri, A., et al., J. Mater. Sc. Mater. Med. 8: 29-37 (1997)). Although pure hydroxyapatite is known to be biocompatible, variations in the precise nature of the forms of calcium phosphate can have a strong effect on the cellular response of cells growing within the scaffold, and thus reduce the biocompatibility of the material (Best, S., et al., J. Mater. Sci. Mater. Med. 8: 97-103 (1997); Eggli, P. S., et al., Clin. Orthop. Rel. Res. 232: 127-138, (1988)).

Furthermore, changes in the degree of crystallinity and purity may also lead to variations in the level of scaffold solubility, which would likely affect the rate of scaffold degradation within a living body. Several authors reported the decomposition of hydroxyapatite powder at temperatures above 1150° C. (Tampieri, A., et al., J. Mater. Sc. Mater. Med. 8: 29-37 (1997)). Thus preserving the composition and crystalline structure of hydroxyapatite during sintering helps ensure that the hydroxyapatite structures are useful for biological applications. A comparison of the XRD patterns of the hydroxyapatite powder used to make the porous hydroxyapatite scaffolds and of the porous hydroxyapatite scaffolds sintered at 1250° C. and 1350° C. showed that the XRD peaks of all three diffraction patterns agreed well with those of standard hydroxyapatite in the Powder Diffraction File (PDF Card No. 9-432). No discernible difference among the three patterns was observed, and no additional phase was identified. This result indicates that the sintering process did not change the composition of the hydroxyapatite. This high thermal stability of the hydroxyapatite scaffolds allows for preparation of a fully densified, porous, hydroxyapatite structure at high sintering temperatures.

The energy dispersive spectrum (EDS) of a porous hydroxyapatite scaffold, prepared using a 45 wt % hydroxyapatite slurry, showed that the stoichiometric ratio of hydroxyapatite was retained after sintering, as suggested by XRD and IR spectroscopy. The scaffolds were made almost entirely of Ca and P with a Ca/P ratio of 1.7 as calculated from the areas enveloped by the spectrum curves of calcium and phosphorous. This result shows that little, if any, other calcium phosphate derivatives, which may affect the solubility, mechanical strength, and biological properties of the scaffolds, existed in the porous hydroxyapatite scaffolds.

The chemical composition of the porous hydroxyapatite scaffolds was further investigated using FTIR. Hydroxyapatite powder used to make the scaffolds, and the porous hydroxyapatite scaffolds were subjected to FTIR. Table 2 shows the infrared band positions and their assignments.

TABLE 2

| | Observed vibrational |
|---|---|
| Assignments | frequencies (cm⁻¹) |
| Structural OH | 3570 |
| H₂O absorbed | 3470 |
| Soluble CO₂ (ν₃) | 2300 |
| H₂O absorbed (ν₂) | 1650 |
| CO₃⁻ group (ν₃) | 1460 |
| CO₃⁻ group (ν₃) | 1420 |
| PO₄ bend ν₃ | 1030 |
| PO₄ stretch ν₁ | 985 |
| CO₃⁻ group | 881 |
| Structural OH | 630 |
| PO₄ bend ν₄ | 570 |

Two bands at 631 and 3570 cm⁻¹ correspond to the vibration of hydroxyl ions. The bands at 1030 and 570 cm⁻¹ are the characteristic bands of phosphate bending vibration, while the band at 981 cm⁻¹ is attributed to phosphate stretching vibration. The bands at 881, 1420 and 1460 cm⁻¹ are indicative of the carbonate ion substitution. The bands at 1650 and 3470 cm⁻¹ correspond to H₂O absorption. There was no discernible spectrum difference between the hydroxyapatite powder and hydroxyapatite scaffold, which further confirms that no chemical decomposition occurred during the hydroxyapatite sintering process.

The porous hydroxyapatite scaffolds should reproduce both the composition and pore morphology of bone to promote the growth of bone cells and blood vessels therein. SEM analysis showed the interconnected, macroporous structures of the scaffolds prepared with slurries of different hydroxyapatite concentrations. All samples exhibited a three dimensional interpenetrating network of structural members and pores. The scaffolds had an average pore size of 400 μm. It is believed that rapid vascularization is required to sustain the mechanical strength of a porous hydroxyapatite scaffold as it gradually degrades within a living body during bone remodeling. An interconnected open pore structure also allows biomolecules and degraded substances to freely flow into and out of the scaffold. A high degree of pore interconnectedness may also promote growth of cells and blood vessels throughout the scaffold.

Table 3 shows the density and porosity of hydroxyapatite scaffolds prepared from slurries of different hydroxyapatite concentrations.

TABLE 3

| Hydroxyapatite Wt. % | Density (gm/cm³) | Porosity |
|---|---|---|
| 35 | 0.397 | 71.40% |
| 40 | 0.460 | 70.05% |
| 45 | 0.499 | 76.90% |
| 50 | 0.783 | 71.00% |

The data set forth in Table 3 show that for scaffolds having the same porosity the density increases with increasing hydroxyapatite concentration. As the concentration of hydroxyapatite was increased, the pores became more interconnected with dense and thick pore walls. Thicker pore walls are advantageous because they confer mechanical strength on the scaffolds. Additionally, high porosity provides a high surface area/volume ratio, and thus favors cell adhesion to the scaffold and promotes bone tissue regeneration.

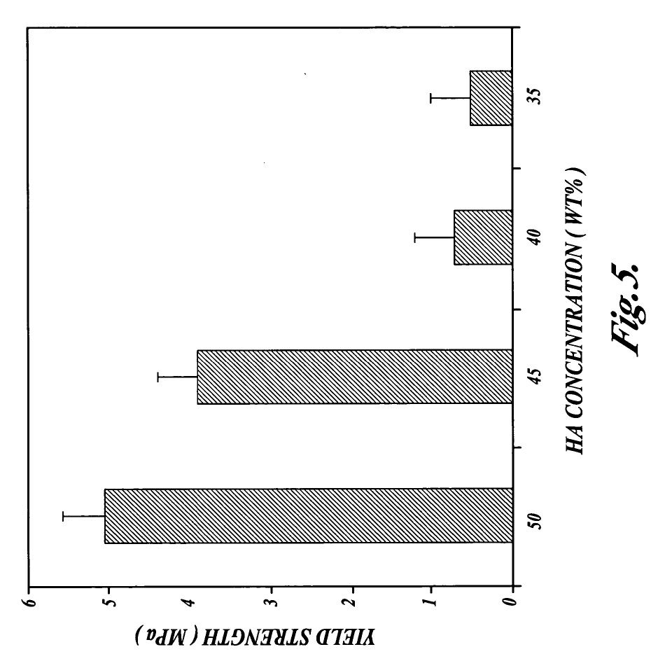

FIGS. 4 and 5 show the elastic modulus and compressive yield strength of the porous hydroxyapatite scaffolds prepared from slurries having different hydroxyapatite concentrations. The compression tests showed that all the samples failed in a manner similar to that for an elastic-brittle foam, exhibiting a linear elastic region followed by a collapse plateau presumably dominated by brittle fracture of the struts. Both the yield strength and elastic modulus of the scaffolds increased rapidly with the increase in hydroxyapatite concentration as a consequence of an increase in pore wall thickness and density of the scaffold. For the increase of hydroxyapatite concentration from 35% to 50%, the yield strength increased from 0.55 MPa to 5 MPa. The elastic modulus ranged from 4 GPa to 7 GPa, which is roughly comparable to those of cortical bone (˜4 GPa-17 GPa) (Currey, J. D., Clin. Orthop. Rel. Res. 73: 210-231 (1970)).

It has been reported that scaffolds fabricated by the gel casting technique have elastic modulus and compressive strengths in the range of 3.6 to 21.0 GPa and 1.6 to 4.7 MPa respectively, with both increasing as porosity decreased (Sepulveda, P., et al., J. Biomed. Mater. Res. 50: 27-34 (2000); Sepulveda, P., et al., “Properties of Highly Porous Hydroxyapatite Obtained by the Gelcasting of Foams,” J. Am. Ceram. Soc. 83: 3021-3024 (2000)). It has been previously reported that hydroxyapatite scaffolds prepared by the polymer sponge method typically possessed a compressive strength of 1.2 MPa and compressive modulus of 8 MPa (Zhang, Y., and M. Zhang, J. Biomed. Mat. Res. 61: 1-8 (2002)). Thus, the present invention provides porous hydroxyapatite structures that have improved mechanical properties compared to porous hydroxyapatite structures prepared using the polymer sponge method. These improved mechanical properties are likely attributable to thicker pore walls and a denser microstructure of the hydroxyapatite scaffolds.

### EXAMPLE 2

This Example describes a method for measuring the compressive strength of porous ceramic structures.

A straight elastic bar of uniform cross section, A, is measured in tension by applying loads at the ends that are distributed evenly over the gage of the specimen. The stress, σ, is calculated using the force applied, F, as

$$σ = \frac{F}{A} \qquad ( 1 )$$

Strain, ε, the normalized deformation is given by

$$ɛ = \frac{{l}_{f} - {l}_{o}}{{l}_{0}} \qquad ( 2 )$$

where, l_{f} is the final length after testing and lₒ is the initial length of the material.

The elastic modulus, E, of the material is the intrinsic property that is calculated from the slope of the linear portion of the stress strain curve, and is given by

$$E = \frac{σ}{ɛ} \qquad ( 3 )$$

An Instron 4505 mechanical tester with 10 kN load cells is used for the compression mechanical test. The specimens to be tested are made cylindrical in shape with a length to diameter ratio of 2:1, which is designed to minimize the end effect imposed by compressive loading. The crosshead speed is set at 0.4 mm/min, and the load is applied until the specimen cracks. Yield stress and elastic modulus are calculated using Eq.1-3. Five samples of each type are tested for mechanical properties, and the results are averaged.

### EXAMPLE 3

This Example describes a method for measuring the average diameter of pores in a porous ceramic structure.

A portion of a porous ceramic structure is coated with gold/palladium under an argon atmosphere. A JEOL 5200 scanning electron microscope is used to produce an image of the coated portion of the porous ceramic structure. The diameter of each pore within a square area of the image is measured. All of the diameter values are added together and divided by the number of pores that were measured. The resulting value is the average pore diameter.

### EXAMPLE 4

This Example describes the preparation, and some physical properties, of porous β-tricalcium phosphate scaffolds, including hydroxyapatite nanofibers, prepared using the methods of the present invention.

Materials: β-TCP (β-Ca₃(PO₄)₂) powder was used as provided by the supplier. Darvan C (Vanderbilt Company Inc.), a 25% aqueous solution of ammonium polymethacrylate, was used as a dispersant. Monofunctional acrylamide C₂H₃CONH₂ and difunctional methylenebisacrylamide(C₂H₃CONH)₂CH₂ were used in the gel-casting process as the polymerizable monomers, and ammonium persulphate (NH₄)₂S₂O₈ and N,N,N,N′ tetramethylethylenediamine(TEMED) as the initiator and catalyst, respectively. All of the foregoing chemicals were purchased from Sigma-Aldrich Corporation. A silicone based defoamer, Surfonal® DF 58 (Air Products and Chemicals), was used as a surfactant. All the slurries were aqueous. De-ionized (DI) water was used in all the experiments. Hydroxyapatite nanofibers were prepared with calcium nitrate tetrahydrate (Ca(NO₃)₂.4H₂O) and ammonium hydrogen phosphate ((NH₄)₂PO₄), obtained from Sigma-Aldrich Corporation. Polypropylene glycol (H[OCH(CH₃)CH₂]ₙOH), used to disperse hydroxyapatite nanofibers, was obtained from Alfa Aesar Corporation.

Synthesis of HA nanofibers: hydroxyapatite nanofibers were prepared using the following chemical reaction:
10Ca(NO₃)₂+6(NH₄)₂HPO₄+8N₄OH→Ca₁₀(PO₄)₆(OH)₂+6H₂O+20NH₄NO₃
19.75 g of (NH₄)₂PO₄ were added to DI water to make a 400 ml solution of diammonium hydrogen phosphate. 300 ml calcium nitrate solution were prepared by dissolving 57.5 g of Ca(NO₃)₂.4H₂O in DI water. The pH of the solution was adjusted to 10.4 by addition of NH₄OH. White precipitates of hydroxyapatite were formed by adding the diammonium hydrogen phosphate solution into the calcium nitrate solution at a rate of 1.5 ml/min under constant stirring. The white precipitates were aged for 100 hours to form hydroxyapatite nanofibers. The nanofibers were washed with DI water until the pH value decreased to 7. The water surrounding the hydroxyapatite nanofibers was then replaced with 1-butanol to prevent the hydroxyapatite nanofibers from aggregation during the drying process. The precipitates were dried at 80° C. and calcined at 400° C. to remove the rudimental organic compound.

Nanocomposite scaffolds: hydroxyapatite nanofibers were mixed with β-TCP powder, along with monomers (acrylamide, methylenebisacrylamde), dispersant (Darvan C) and surfactant (Surfonal®), to make ceramic slurries with 75 wt % solid loading. The amount of hydroxyapatite nanofibers ranged from 0, 1, 2, 3, 4 and 5 wt %. The slurries were deagglomerated by ball milling for 24 hours and subsequently de-aired under a vacuum environment until there was no further release of air bubbles from the slurries. Catalyst (ammonium persulphate) and initiator (N,N,N,N tetramethylethylenediamine) were added to the slurries to polymerize the monomers.

Polyurethane foam cut into desired shapes and sizes was immersed into the slurries under vacuum to force the ceramic slurries into the pores of the foam. The samples were placed in a nitrogen chamber during polymerization to avoid oxygen contamination, which may inhibit the polymerization process. The polymerized samples were dried in air for 24 hours and heated at a rate of 1° C./min to 600° C. The samples remained at this temperature for 1 hour to burn out the polyurethane foams, and then were sintered by increasing the temperature at a rate of 3° C./min to the sintering temperature for a dwell time of 1 hour. The sintering temperature, which depends on the hydroxyapatite nanofiber content in the scaffold, was evaluated with a dilatometer.

X-Ray Diffraction Analysis: X-ray diffraction (XRD) was used to characterize the crystallinity, chemical composition, and structure of the materials. XRD experiments were performed on hydroxyapatite nanofibers and biphasic calcium phosphate ceramics before and after sintering, with a Phillips X'Pert using CuK_{α} radiation at 20 mA, 40 kV. Scans were performed with 20 values from 20° to 40° at a rate of 0.2°/min.

Transmission Electron Microscopy (TEM): The morphology of hydroxyapatite nanofibers was observed with a transmission electron microscope (CM 100 TEM) at an accelerating voltage of 100 kV. Samples were prepared by drying the solution of hydroxyapatite nanofibers on a copper grid, fitted with a carbon support film, under vacuum. The solution was prepared by dispersing 0.05 gm of hydroxyapatite nanofibers in 0.5 vol % polypropylene glycol under sonication (550 Sonic Dismembrator, Fisher Scientific, Pittsburgh, Pa.).

Determination of Sintering Temperature: The sintering temperature of biphasic calcium phosphate was determined with a Netzsch Dilatometer. Samples were heated in Netzsch tube furnace from 20° C. to 1400° C. at a rate of 3° C./min.

Scanning electronic microscopv (SEM): Morphology of porous composites was studied with a JEOL 5200 scanning electron microscope. The samples were pre-coated with gold/palladium under an argon atmosphere.

Mechanical Testing: The specimens of porous scaffolds were cylindrical in shape (2 mm height×1 mm diameter) with a length to diameter ratio of 2:1. An Instron 4505 mechanical tester with 10 KN load cells was used for the compression mechanical tests. The crosshead speed was set at 0.4 mm/min, and the load was applied until the scaffold was crushed completely. The elastic modulus was calculated as the slope of the initial linear portion of the stress-strain curve. The compressive strength was defined as the maximum compressive strength obtained during testing before densification. The toughness was calculated from the area under the stress displacement curve from zero to the point where the final densification starts. The mechanical properties of five samples of each type were tested.

Results: TEM of a sample of hydroxyapatite nanofibers synthesized as described in this Example revealed that the nanofibers had a length of about 100 nm and a diameter of about 20 nm. The hydroxyapatite nanofibers, synthesized as described in this Example, were aged for 100 hours, yielding a well-crystallized structure. The aging process ensured that the reagents were fully reacted and precipitated. The prolonged aging time reduced crystal strains in the matrix and recrystallized non-homogeneous grains to generate more homogeneous grains. Comparison of the XRD pattern of the hydroxyapatite nanofibers with the diffraction pattern of standard crystalline hydroxyapatite showed that the peak locations for the hydroxyapatite nanofibers agreed well with those of standard crystalline hydroxyapatite.

The sintering temperature, at which the samples attained their minimum change in length, was 1274° C. for pure β-TCP, and was 1144° C. for the sample with 5 wt % of hydroxyapatite nanofibers incorporated. The addition of nanofibers reduced the sintering temperature of the ceramic matrix, a phenomenon attributed to their high surface reactivity. A lower sintering temperature is favored because it can reduce the cost of material processing and prevent the second phase decomposition which often occurs at high temperature and deteriorates the biological and mechanical properties of biomaterials.

The porosity of the sintered scaffolds, as measured with the Archimedes method in distilled water, was ˜73%±0.4. SEM analysis revealed that the scaffolds had an interconnected macroporous structure with a pore size in the range of 300-400 μm. The macroporous structure promotes cell growth and vascularization.

Overall, the compressive strength and compressive modulus of the scaffolds increased with increasing concentration of the hydroxyapatite fibers. The scaffold containing 5 wt % hydroxyapatite nanofibers attained a compressive strength of 9.8±0.3 MPa, which is comparable to the high end of compressive strength of cancellous bone (2-10 MPa).

Fracture toughness, the resistance of a material to crack propagation, is an important parameter to assess the susceptibility of a scaffold to failure. The fracture toughness of the porous scaffolds was evaluated by the area under the stress displacement curve from zero to the point of the maximum stress. The fracture toughness is seen to increase from 1.00±0.04 to 1.72±0.02 Mpa/mm as the concentration of HA fibers increased from 0 wt % to 5 wt %.

While the preferred embodiment of the invention has been illustrated and described, it will be appreciated that various changes can be made therein without departing from the spirit and scope of the invention.

1. A method for making a porous ceramic structure, the method comprising the steps of:
(a) contacting a porous body defining a multiplicity of pores with a liquid ceramic composition for a period of time sufficient for the liquid ceramic composition to penetrate the pores;
(b) polymerizing the liquid ceramic composition that has penetrated the pores; and
(c) destroying the porous body to produce a porous ceramic structure.

2. The method of claim 1 wherein the porous body consists essentially of polystyrene or polyurethane.

3. The method of claim 1 wherein the porous body consists essentially of an elastically resilient sponge.

4. The method of claim 1 wherein the porous body is contacted with the liquid ceramic composition by immersing the porous body in the liquid ceramic composition.

5. The method of claim 4 wherein the porous body, immersed in the liquid ceramic composition, is subjected to a vacuum.

6. The method of claim 1 wherein the liquid ceramic composition comprises a member of the group consisting of hydroxyapatite, P-tricalcium phosphate, and a bioglass.

7. The method of claim 1 wherein the liquid ceramic composition comprises hydroxyapatite.

8. The method of claim 1 wherein the liquid ceramic composition comprises β-tricalcium phosphate.

9. The method of claim 1 wherein the porous body is contacted with the liquid ceramic composition for a period of time of less than half an hour.

10. The method of claim 1 wherein the liquid ceramic composition is polymerized by adding a polymerizing agent to the liquid ceramic composition before or during contacting the porous body with the liquid ceramic composition, and initiating polymerization of the polymerizing agent before, during, or after contacting the porous body with the liquid ceramic composition.

11. The method of claim 10 wherein the polymerizing agent is added to the liquid ceramic composition before contacting the porous body with the liquid ceramic composition.

12. The method of claim 10 wherein the polymerizing agent is added to the liquid ceramic composition at the same time as contacting the porous body with the liquid ceramic composition.

13. The method of claim 10 wherein the polymerizing agent is selected from the group consisting of acrylamide, methylenebisacrylamide, 2-hydroxyethyl methacrylate and ethylene dimethacrylate.

14. The method of claim 10 wherein acrylamide and methylenebisacrylamide are added to the liquid ceramic composition before or during contacting the porous body with the liquid ceramic composition.

15. The method of claim 10 wherein the porous body is immersed in the liquid ceramic composition, a polymerizing agent is added to the liquid ceramic composition before or during immersion of the porous body in the liquid ceramic composition, and the porous body is removed from the liquid ceramic composition before polymerization of the liquid ceramic composition is complete.

16. The method of claim 1 wherein the liquid ceramic composition further comprises nanoparticles.

17. The method of claim 16 wherein the nanoparticles have a longest dimension that is less than 1 μm.

18. The method of claim 17 wherein the nanoparticles have a longest dimension that is less than 500 nm.

19. The method of claim 17 wherein the nanoparticles have a longest dimension that is less than 100 nm.

20. The method of claim 16 wherein the nanoparticles consist essentially of a member of the group consisting of hydroxyapatite, P-tricalcium phosphate, and a bioglass.

21. The method of claim 16 wherein the nanoparticles are present in the liquid ceramic composition at a concentration of less than 10% (w/w).

22. The method of claim 16 wherein the nanoparticles are present in the liquid ceramic composition at a concentration of less than 5% (w/w).

23. The method of claim 1 wherein the porous body is destroyed by incineration.

24. The method of claim 1 further comprising the step of sintering the porous ceramic structure.

25. The method of claim 1 wherein the porous ceramic structure has a compressive strength of at least 5 MPa, and a porosity of between about 40% and about 78%.

26. The method of claim 1 wherein the porous ceramic structure has a compressive strength of from 5 MPa to 10 MPa, and a porosity of between about 40% and about 78%.

27. A porous ceramic structure having a compressive strength of greater than about 5 MPa, and a porosity of between about 40% and about 78%.

28. A porous ceramic structure of claim 27 having a compressive strength in the range of from 5 MPa to 10 MPa, and a porosity of between about 40% and about 78%.

29. A porous ceramic structure of claim 27 having a compressive strength in the range of from 5 MPa to 10 MPa, and a porosity in the range of from 50% to 78%.

30. A porous ceramic structure of claim 27 having a compressive strength in the range of from 5 MPa to 10 MPa, and a porosity in the range of from 60% to 78%.

31. A porous ceramic structure of claim 27 having a compressive strength in the range of from 5 MPa to 10 MPa, and a porosity in the range of from 65% to 78%.

32. A porous ceramic structure of claim 27 having a compressive strength in the range of from 5 MPa to 10 MPa, and a porosity in the range of from 70% to 78%.

33. A porous ceramic structure of claim 27 comprising a multiplicity of pores defined by pore walls, wherein the pore walls comprise nanoparticles.

34. A porous ceramic structure of claim 33 having a compressive strength in the range of from 5 MPa to 10 MPa, and a porosity of from 60% to 78%.

35. A porous ceramic structure of claim 33 wherein the nanoparticles consist essentially of a member of the group consisting of hydroxyapatite, β-tricalcium phosphate, and a bioglass.

36. A porous ceramic structure made by a method comprising the steps of:
(a) contacting a porous body defining a multiplicity of pores with a liquid ceramic composition for a period of time sufficient for the liquid ceramic composition to penetrate the pores;
(b) polymerizing the liquid ceramic composition that has penetrated the pores; and
(c) destroying the porous body to produce a porous ceramic structure.

37. A porous ceramic structure of claim 36 wherein the porous ceramic structure has a compressive strength of greater than about 5 MPa, and a porosity of from 40% to 78%.

38. A method for growing bone, the method comprising the step of culturing bone cells in a porous ceramic scaffold, that has a compressive strength of at least about 5 MPa, and a porosity of from 40% to 78%, for a period of time sufficient for bone to form.
